(19) United States
(12) Patent Application Publication
(10) Pub. No.: US 2004/0117360 A1
(43) Pub. Date: Jun. 17, 2004

(54) Knowledge acquisition apparatus and method

(76) Inventors: Christopher William Preist, Bristol (GB); Claudio Bartollino, Menlo Park, CA (US); Andrew Robert Byde, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/473,605

(22) PCT Filed: Apr. 11, 2002
(86) PCT No.: PCT/GB02/01711

(30) Foreign Application Priority Data
Apr. 11, 2001 (GB) 0109073.7
Jul. 27, 2001 (GB) 0118446.4

(51) Int. Cl. G06F 17/30

(52) U.S. Cl. 707/3

(57) ABSTRACT

Preference maps may be used in automated negotiating systems. The creation of a preference map is an onerous duty in cases where many parameters are to be negotiated. By automating the creation of user questions and iteratively producing further questions based on a partially created preference map, the burden of generating the preference map may be reduced. This allows more complex negotiations over greater numbers of parameters to be carried out using automatic agents.

This invention relates to a method of recording user preferences for use particularly though not exclusively, in the field of automated negotiating agents, and to a preference map generator.

In order to automate a multi-parameter negotiation (for example a negotiation having the parameters, price, delivery time and quality), a user must provide information about their preferences over the space of possible outcomes. Ideally, a user specifies exactly the utility of any given contract so that the negotiating systems are able to compare contracts easily. However, in a multi-parameter negotiating scenario, the possible combinations of contracts may be very large. Thus it is impractical to expect a user to specify the utility of every possible combination.

Hitherto, it has only been possible to generate a preference map (embodying the user's preferences over the space of possible outcomes) using a questionnaire which requests user input for particular points in the preference map. An example of such a prior art system is that set out in “Negotiation Decision Functions for Autonomous Agents”; Faratin, Sierra & Jennings; International Journal of Robotics and Autonomous Systems 1998 and also In “A Multi-Attribute Utility Theoretic Negotiation Architecture for Electronic Commerce”; Mihai, Barbuceanu and Yai-Kau Lo; pages 15-30, Proceedings of Agent-Mediated Electronic Commerce Conference 2000. Both of these proposals require a user either to explicitly enter all points on the preference map or to enter a known function which is used as a preference map.

In accordance with a first aspect of the invention there is provided a method of recording user preferences comprising receiving an abstract contract in the form of a plurality of negotiable parameter identities, issuing user queries according to a predetermined query strategy, recording user answers received in response to the user queries in the form of respective discrete points or surfaces in a preference map, and interpolating between the discrete points or surfaces to populate the map without issuing additional user queries.

Thus, following the provision of an abstract contract (which may be considered as the contract template), the method of the present invention automatically queries the user in order to derive known points and/or surfaces on the preference map. The method then interpolates and/or extrapolates between these points or surfaces to generate a complete preference map. The query strategy is designed to strike a balance between certainty in the preference map and minimised number of queries for the user. Therefore, the invention proposes an agent which is operable automatically to acquire knowledge and record user preferences in a preference map. This advance on the prior art manual questioning systems allows more complex negotiations over larger numbers of parameters to be carried out using negotiating agents.

In accordance with a second aspect, the invention provides a preference map generator comprising a contract input arranged to receive an abstract contract in the form of a plurality of negotiable parameter values, a strategy processor arranged to issue user queries according to a predetermined query strategy, a database arranged to record user answers received in response to the user queries in the form of respective discrete points or surfaces in a preference map, and an estimator arranged to Interpolate between the discrete points or surfaces to populate the map without causing the issuance of additional user queries.

Embodiments of the invention will now be described by way of example with reference to the drawings in which:—

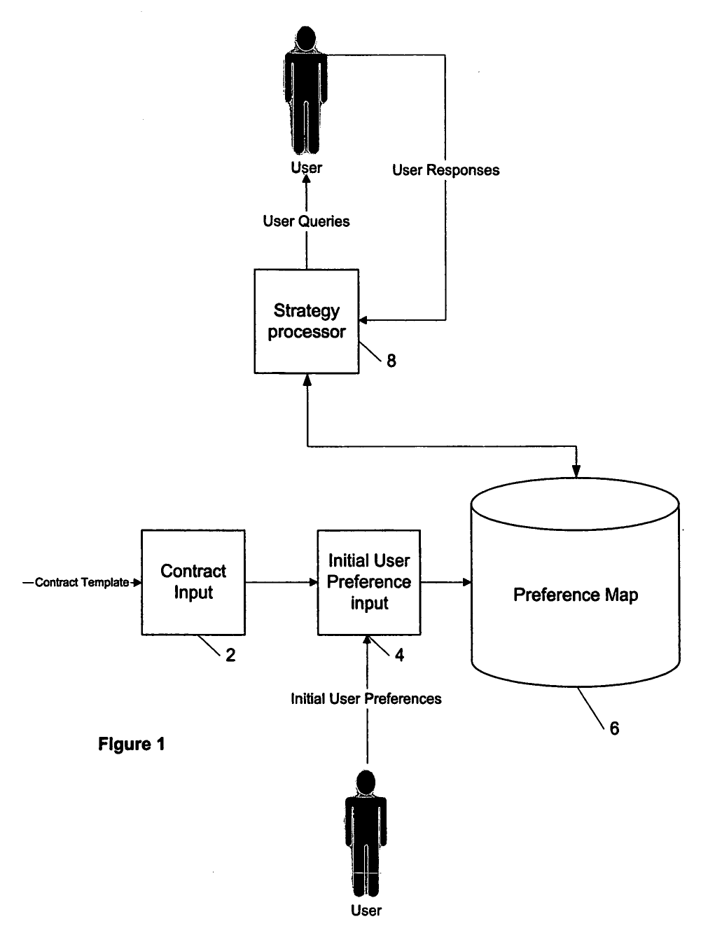

FIG. 1 is a schematic block diagram of a preference map generator in accordance with the invention;

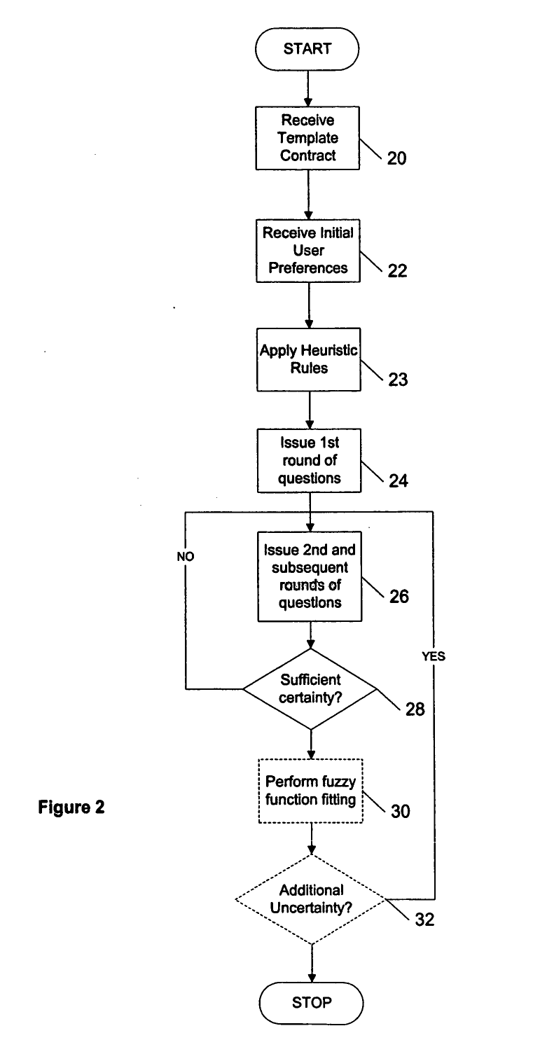

FIG. 2 is a flow chart showing the steps involved In generating a preference map in accordance with the invention; and

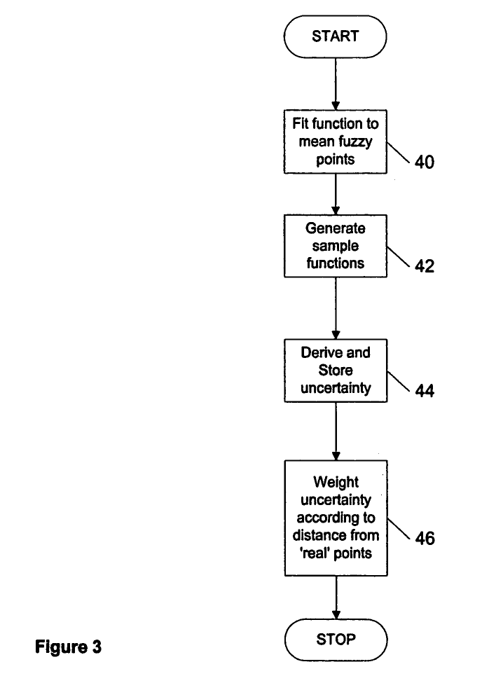

FIG. 3 is a flow chart showing an embodiment of a “fuzzy” function fitting method in accordance with the invention.

As discussed above, before an automated negotiation takes place, it is necessary for each negotiating party's negotiating engine to be constructed to conduct the negotiation in accordance with the party's preferences. Conventionally, the preferences are embodied using some form of utility function which maps utility or usefulness to the party against one or more parameter in the negotiation. In the case of a multi-parameter negotiation, the utility function is commonly termed a “preference map” which can be visualised as a bumpy utility surface in as many dimensions as there are parameters to be negotiated over.

The apparatus and methods described below allow a preference map to be constructed automatically based on as few a number of user queries as possible.

A contract template or abstract contract is in the preferred embodiment represented by a set of parameters that can take one or more values. One of these parameters is typically assumed to be price. During the negotiation, the negotiating parties must agree on acceptable instantiated values for all the parameters (in other words a specific contract). The preference map for each party aims to provide the utility of any fully instantiated contract.

Parameters typically may be of three types. The first type is a numerical range such as price, the second type is an ordered set such as quality which could have values low, medium and high. The third type is an unordered set such as colours which could, for example, be pink, blue or yellow. The invention is not limited to these types of parameters.

With reference to FIG. 1, a map generator has a contract input 2 which receives an abstract or template contract. The contract template will typically comprise information about the set of parameters to be negotiated and also the type of each parameter selected from the example three types discussed above.

The map generator may also include an initial user input 4 which takes initial information which is volunteered by the user. This information typically relates to respective single parameters and defines a surface on the preference map. For example, the user may specify for a range or an ordered set that they prefer “high” or “low” values. Alternatives to this are “Don't Care” or “Depends”.

“Don't Care” means that any value of a particular parameter is equally preferred. “Depends” indicates an inter-relation between parameters and may also generate large surfaces on the preference map. One example of such a situation might be in which the parameters are “type of goods” and the level of insurance cover for transporting the goods. If the goods are valuable then the insurance cover cost may be allowed to be “high”. On the other hand, if the goods are of low value, the user preference for insurance costs may be “low”.

Furthermore, the user may specify maximum and or minimum acceptable values which will also generate surfaces on the preference map.

This technique of initial user input may populate large areas of the preference map so that further questioning to refine the surface may be reduced.

A similar approach may be taken to unordered sets. For example, a user may place some or all of the elements in an unordered set into an order of preference. Also, some of the elements in the set may have a “Don't Care” preference which may be tackled in the same way as the ordered set or numerical range discussed above. In the case of a “Depends” user Initial preference for an unordered set, one approach is to create separate preference maps for each possible value of a “Depends” parameter.

Thus with this initial user information, an initial preference map 6 may be generated.

A strategy processor 8 then examines the preference map to determine which parameters are already well bounded by the initial user preferences. The strategy processor 8 then issues queries to a user in accordance with a predetermined strategy In order to refine the preference map.

The strategy used in the preferred embodiment is to determine price sensitivity for each parameter of the contract. This is achieved by issuing a series of user queries in which all parameters are fixed (to values which the user) is likely to find acceptable based on the initial user preferences except for one parameter. By varying this one parameter in several queries, it is possible to identify what the user is willing to pay for several values of that parameter. This may be achieved by presenting the user with various offers which have a binary yes/no response possibility. For a parameter which is a numerical range (such as delivery time) the number of questions would typically be of the order of 3. For an ordered or unordered set, more queries may be necessary. Following this initial questioning round, a series of points will be generated in the multi-dimensional preference space which are prices at which the user is willing to accept a series of specific contracts. This strategy is carried out for each parameter which does not have a price sensitivity indication based on the initial user preferences input into the initial preference input 4.

It will be appreciated that the Initial user preference input may also include defined points rather than the ranges which define surfaces in the map discussed above.

In a second round of questioning, the strategy processor examines the points which have been derived from the first round of questioning to determine If there is an inter-relationship between any of the parameters. This may be achieved using conventional correlation algorithms. If any of the parameters are correlated above a predetermined threshold then the second round of questioning fixes all points except the correlated parameters and attempts, to refine the surface of the preference map in terms of the inter-relationship between those parameters by issuing queries with several combinations of values of those parameters.

The user may optionally supply an indication of “confidence” of either the user initial preferences or the answers to the queries issued by the strategy processor. Depending on the input confidence level, the preference map may be created for example so that a single point indicating that a contract will be accepted for $100 but not at $101 may instead be defined as a probabilistic or “fuzzy” spread around $100. If no input confidence level is supplied, a default confidence level may be used instead.

In a further preferred embodiment, the strategy processor operates to apply built-in heuristic rules which are operable to perform extrapolation or interpolation between the existing points and surfaces already defined. For example, if one of the parameters is “Quantity” a heuristic rule may be applied which generates hypothetical points in the quantity dimension. If, for example, a given contract with a quantity N has a maximum acceptable price of X then it would be expected that a contract of quantity M will have a maximum acceptable price less than or equal to MX/N. Such a rule is likely to be bounded by additional rules or points indicating that the user has a maximum desirable quantity or overall maximum price. However, it will be seen that such heuristic rules may populate large areas of the preference map with an expected high degree of accuracy.

The steps carried out by the apparatus in FIG. 1 may be summarised in the flow chart of FIG. 2. Initially, the apparatus receives an abstract contract (step 20). The apparatus may also receive initial user preferences (step 22) which may, for example, be preferences about particular parameters such as a preference for a high or low value or a preference order for an unordered set, maximum and/or minimum values for a particular parameter.

The apparatus then (step 24) starts a first round of user queries which are designed to identify the relationships between different parameters. This is achieved as discussed above by fixing all except one parameter and determining the price sensitivity of that parameter by issuing a series of questions over the range of that parameter.

In step 26, the strategy processor of FIG. 1 then operates to issue a second round of questions depending on the results of the first round of questions. The second and subsequent round of questions continues until a desired level of certainty in the preference map is determined. The second round of questions also seeks to determine the relationships between parameters which appear to be correlated in some way based on the first round of questions.

Optionally, in step 23, the map may be populated using heuristic rules of the type described above. This means that the preference map is as populated as possible before any queries are issued to the user.

As a final step, if the user map is a probabilistic (or “fuzzy”) user map then a round of “fuzzy” function fitting (step 30) may be applied and this In turn may reveal areas of uncertainty which require additional questioning rounds to be applied (step 26).

Once these steps have been completed, the preference map is ready for use by the negotiating system. It will be noted that as discussed for example in the applicant's co-pending British Patent Application of even date entitled “Utility Scoring Method and Apparatus”, the contents of which are incorporated by reference herein, it is possible that the negotiating system will detect inconsistencies in the preference map during negotiating rounds. If this occurs, the areas of uncertainty may be flagged and additional questions issued (step 26) to refine those areas of the preference map. Thus, the system may operate to start with a loosely defined preference map which is used in a safe mode (only high certainty areas of the map are used). If uncertainty becomes apparent in areas of the preference map which are being used for the particular negotiating round in question, then the system (in conjunction with a suitable negotiating system as described in co-pending application No. (A1856-1) operates to refine that area of the preference map to improve certainty and therefore reduce the risk of performing incorrect negotiating steps.

A suitable “fuzzy” function fitting schema (for use in step 30 of FIG. 2) is now described below with reference to FIG. 3.

Typically, a “fuzzy” point on the preference map is a probability distribution over the product of the parameter space with real numbers obtained by the strategy processor 8. It will typically not be practical to obtain the probability distribution from the user so in the preferred embodiment, the distribution is assumed to have a standard form such as a uniform distribution or a Gaussian distribution over a multi-dimensional interval. The extent of this distribution may be determined according to the “confidence level” input by a user in response to a question. By using a standard distribution, it is not necessary to store the details of the distribution but rather certain key parameters which define the extent and shape of the distribution. This reduces the storage space required for the preference map 6.

The “fuzzy” function fitting algorithm typically is based on a known fitting procedure such as a linear regression procedure based on least squares of deviance. In theory, this may be applied to the joint probability set of the “fuzzy” points which have been created following the query rounds produced by the strategy processor. Thus for each possible set of real points corresponding to the set of “fuzzy” points which have been created, there is a unique function defined by the fixed fitting procedure. The function is then given density equal to the joint density of the real points which are chosen from the “fuzzy” point distribution. As a result, the “fuzzy” function assigns a probability density to each function over parameter space that could arise from the fixed fitting procedure and hence assigns a probability density to the function value at each point in parameter space. In this way, the “fuzzy” function provides estimate of the user's utility of the contracts in parameter space which have not explicitly been defined by the user. This theoretical procedure however, is computationally complex.

A simplified procedure as set out below is likely to give adequate estimating accuracy whilst significantly reducing the computational complexity.

This simplification relies on the concept that an estimate of the ideal “fuzzy” function may be generated in terms of an average function with an indication of uncertainty at each point in the preference map. Thus, in the first step of the flow chart (step 40) a function is fitted to the mean of the “fuzzy” points in the preference space generated by the strategy processor. Then, in order to determine the uncertainty of this average function, the strategy processor 8 samples the function (step 42) by selecting sample sets of real points determined by the strategy processor and measuring the uncertainty of the data which is generated by the function. The uncertainty may be stored (step 44), for example, as a variance of the outputs of the functions when presented with data from the real points produced by the strategy processor during its questioning rounds. Alternatively, the uncertainty may be stored as the absolute maximum and minimum values encountered in the sample function output values generated from the sample set of real points.

An alternative to the sample function approach to generating uncertainty estimates is to perform function fitting on extreme samples of the “fuzzy” points, for example, to take all the maximum values for the “fuzzy” points and then all the minimum values for the “fuzzy” points. A large difference between the minimal and maximum values for the “fuzzy” points indicates an area of great uncertainty.

As a further enhancement, the uncertainty derived in this way may be weighted according to the distance from a known real point generated by querying the user. In this way, the confidence placed in the estimate is decreased as the estimate moves further away from “hard” or real points on the preference map. Data regarding distance may be stored separately and returned with the “fuzzy” range of utility scores for a particular contract instantiation or alternatively may be convoluted with the “fuzzy” function so that the “fuzzy” range itself is adjusted to take account of distance from hard points (step 46).

This may be used to “generalise” points entered by a user which are “certain” and have no inherent confidence level or “fuzzy range”. In this way a fuzzy function may be generated from a set of firm points.

1. A method of recording user preferences comprising:—
(a) receiving an abstract contract in the form of a plurality of negotiable parameter identities,
(b) issuing user queries according to a predetermined query strategy,
(c) recording user answers received in response to the user queries in the form of respective discrete points or surfaces in a preference map, and
(d) interpolating between the discrete points or surfaces to populate the map without issuing additional user queries.

2. A method according to claim 1, wherein the abstract contract includes information specifying the type of each parameter and/or the valid range of each parameter.

3. A method according to claim 1 or claim 2, wherein the user volunteers information about preferences for at least one of the parameters such as high, low, don't care and/or depends.

4. A method according to any preceding claim, wherein the user volunteers a maximum and/or minimum value for at least one of the parameters.

5. A method according to any preceding claim, wherein the predetermined query strategy comprises issuing a plurality of user queries in which all parameters except a subset of parameters are fixed and varying the values of the parameters in the subset in each of the said plurality of queries.

6. A method according to any preceding claim, wherein at least one user answers includes a confidence value which determines the permissible deviation from the values specified in the corresponding user query.

7. A method according to any preceding claim wherein the interpolation is carried out using a predetermined logical rule which is based at least in part on the type of data represented by a parameter in the abstract contract.

8. A method according to any preceding claim, wherein the interpolation is carried out using a function fitting process based on known points in the preference map such as the means, maxima or minima of known points.

9. A method according to claim 8, wherein the function fitting process is used to determine areas of uncertainty in the interpolated preference map which exceed a predetermined threshold and wherein the method further includes generating additional user queries to provide improved certainty in these areas of uncertainty.

10. A preference map generator comprising:—
(a) a contract input arranged to receive an abstract contract in the form of a plurality of negotiable parameter values,
(b) a strategy processor arranged to issue user queries according to a predetermined query strategy,
(c) a database arranged to record user answers received in response to the user queries in the form of respective discrete points or surfaces in a preference map, and
(d) an estimator arranged to interpolate between the discrete points or surfaces to populate the map without causing the issuance of additional user queries.

11. A generator according to claim 10, wherein the contract input is arranged to receive an abstract contract the which includes information specifying the type of each parameter and/or the valid range of each parameter.

12. A generator according to claim 10 or claim 11, wherein the contract input is arranged to receive voluntary information from a user including information about preferences for at least one of the parameters such as high, low, don't care and/or depends.

13. A generator according to any of claims 10 to 12, wherein the contract input is arranged to receive voluntary information from a user including a maximum and/or minimum value for at least one of the parameters.

14. A generator according to any of claims 10 to 13, wherein the strategy processor is operable to issue a plurality of user queries in which all parameters except a subset of parameters are fixed in which the values of the parameters in the subset are varied in each of the said plurality of queries.

15. A generator according to any of claims 10 to 14, wherein the contract input is arranged to receive a user answer and a confidence value which determines the permissible deviation from the values specified in the corresponding user query.

16. A generator according to any of claims 10 to 15, wherein the interpolation processor is arranged to carry out the interpolation using a predetermined logical rule which is based at least in part on the type of data represented by a parameter in the abstract contract.

17. A generator according to any of claims 10 to 16, wherein the estimator is arranged to carry out the interpolation using a function fitting process based on known points in the preference map such as the means, maxima or minima of known points.

18. A generator according to claim 17, wherein the estimator is operable to cause the strategy processor to generate additional user queries to provide improved certainty in areas of uncertainty in the interpolated preference map which are determined during the function fitting process to exceed a predetermined threshold.

19. A method of interpolating a series of multidimensional points to generate a fuzzy surface comprising:—
(a) receiving a representation of each of a plurality of multidimensional points, the representation including the point coordinates and an uncertainty measure for each point,
(b) generating a function by fitting a surface to the mean coordinates of each point,
(c) determining the uncertainty of the generated function by sampling the function at at least one of the received coordinate locations and to measure the uncertainty of the function at that point.
(d) storing the measured uncertainty.

20. A method according to claim 19, wherein the measured uncertainty is stored as a variance value for a sampled point.

21. A method according to claim 19, wherein the measured uncertainty is stored as a maximum and a minimum value for a sampled point.

22. A method of interpolating a series of multidimensional points to generate a fuzzy surface comprising:—
(a) receiving a representation of each of a plurality of multidimensional points, the representation including the point coordinates and an uncertainty measure for each point,
(b) generating a function by fitting a surface to the maximum coordinates of each point, and
(c) generating a function by fitting a surface to the minimum coordinates of each point.
